(19) United States
(12) Patent Application Publication
(10) Pub. No.: US 2003/0214273 A1
(43) Pub. Date: Nov. 20, 2003

(54) Power supply for USB powered wireless communication devices

(75) Inventors: Kian Yen Mah, Singapore (SG); Raymond Jiang Chek Bo, Singapore (SG); Poh Kam Wong, Singapore (SG)

Correspondence Address: Raymond Bo, iWOW Connections Pte Ltd, 13, Serangoon North Ave 5, #03-00, Singapore, 554787, SG

(73) Assignees: Mah Kian Yen; Raymond Bo; Wong Poh Kam

(21) Appl. No.: 10/146,882

(22) Filed: May 17, 2002

(51) Int. Cl. G05F 1/40

(52) U.S. Cl. 323/271

(57) ABSTRACT

This invention describes a new Power Supply System that is able to supply a Wireless Communication Device that draws periodic, high current burst-type pulse from a stable bus-powered system like Universal Serial Bus (USB).

The main claim is for a power supply system consisting of a current limiting device and a charge storage device. It can supply power to the digital wireless device that required high power for transmission without overloading the source

### BACKGROUND

This invention describes a new Power Supply System that is able to supply a Wireless Communication Device that draws periodic, high current burst-type pulse from a stable bus-powered system like Universal Serial Bus (USB). Presently, if a Wireless Communication Device is drawing power from the USB of a notebook the high burst-type pulse current may overload the system causing the system to malfunction. Our invention solves this problem.

This invention is made in the field of Wireless Communications.

### SUMMARY

Universal Serial Bus “USB” has become the new Personal Computer “PC” peripheral communication standard which replaced the legacy Serial Communication Port. Wireless Digital Communication Devices like Cellular modem, Wireless LAN (Local Area Network) and so on will be equipped with the USB connections. One of the extra benefits for these devices with USB is to be powered by the USB bus itself. As a result, they will not need any external DC power supply or batteries for operation. However the power pattern of the digital wireless device is like a pulse train of high current. This is not compliant to the USB bus-powered specification. The invention here describes a power system that is used in the wireless device to conform to the USB specification.

For USB-powered devices, the current drain specification is very stringent. This is to ensure that the bus is not overloaded. The device is not allowed to drain beyond current limit set by the bus at anytime. This is good enough for most of the digital device. However, the power characteristic of a digital wireless device is very different. It has high peak current pulse drain and relatively low average DC current drain. (Refer to FIG. 1) For example, GSM cellular transmits with 2W power in 577 μs pulse train. The current drain is as high as 2A during the transmission. However the average DC current is only 300 mA. Example of an USB, specification stipulates a maximum current drain of 500 mA. The peak current requirement exceeds the current limit of USB. Hence a power supply system is required to draw power from the bus power supply to the wireless device without overloading the bus power supply.

[image]

### DETAIL DESCRIPTION OF INVENTION

General Description

The innovation is in a power supply system design for wireless communication devices that are powered by USB. This power supply system resides in the Wireless Communication Device. It takes a steady power from the USB and supplies the high burst-type current required by the Wireless Communication Devices (w.r.t. FIG. 1). There are two portions in this new power supply system, a current limiting device and a charge storage device. The current limiting device limits the current drain from the bus below the maximum current. The charge storage device serves as a buffer for the peak load current.

Definition of Specification

In a bus-powered system, the maximum current drain, Imax, of a device is fixed. For the digital wireless device, there is a range of supply voltage for proper operation. So the supply voltage must be within the minimum voltage, Vmin and maximum voltage, Vmax.

Design Specifications

| | Minimum | Maximum |
|---|---|---|
| Current Drain from Bus (USB), Ic | — | Imax |
| Supply Voltage to Load (Wireless Device), | Vmin | Vmax |
| Vc | | |
| Peak Load Current | — | Ipeak |
| Average Load Current | — | Iave |

For this power system to function, one condition must be satisfied:

Iave≦Imax

System Structure

There are two portions in the power supply system, a current limiting device and a charge storage device. The current limiting device limits the current drain from the bus below the maximum, Imax. The charge storage device serves as a buffer for the peak load current. The capacity of the storage device can be estimated using

C≧((Ipeak−Imax)×t)/(Vmax−Vmin)

Where

Ipeak—Peak load current

Imax—Maximum current drain from bus

t—Duration of the peak load current pulse

Vmax—Maximum operating voltage of the load

Vmin—Minimum operating voltage of the load

Operation Sequence

When the device is first power up, the load draws power from the Bus Power Supply through the Current Limiting Device. At the same time, the charge storage device is charging up to the maximum operating voltage, Vmax, of the load.

(I) When Operating Current Iop is Less Than Average Current Supplied I ave.

Iop<Iave.

[image]

(II) When Operating Current Iop is More Than the Average Current Supplied I ave Iop>Iave.

Then when the high current load is turn on, the load current is supplied by the Bus and the Charge Storage Device together. The formula to work out the Capacity of the Charge Storage Device required is

C≧((Ipeak−Imax)×t)/(Vmax−Vmin)

With this Capacity, the supply voltage at the load do not drop below minimum operating voltage, Vmin. After the high current pulse, a new cycle is started again where the Charge Storage Device is charged up back to the maximum operating voltage, Vmax.

[image]

[image]

Advantages

1. This invention allows a Wireless Communication Device to draw high burst-type current from a stable bus-powered system like Universal Serial Bus (USB) without compromising the USB current specifications.

2. This invention requires few part count and the design is governed by the formulae stated in earlier section; this allows implementation in all Wireless Communication Devices that needs to derive power from the USB.

Alternatives

1. The alternative to this solution is to provide a separate power source like a Lithium Ion Battery within the Wireless Communication Device. In this implementation, the Device will need to be charged separately with a DC charger before use.

Our claims are:

1) A power supply system consisting of a current limiting device and a charge storage device. It can supply power to the digital wireless device that required high power for transmission without overloading the source. The wireless communication device has a periodic transmission time slot for transmission. The power supply system makes use of the non-transmission time to charge up the charge storage device. Then in the transmission time slot, power is drawn from the Bus Power Supply and the discharge of the Charge Storage Device.

2) The current limiting device in claim 1 can be realized with a current limiter that has a current rating does not exceed the maximum allowed current.

3) The current limiting device in claim 1 can also be realized with a voltage regulator that has a short circuit current not exceeding the maximum allowed current and regulator voltage at the maximum operating voltage, Vmax.

4) The charge storage device in claim 1 can be realized with a high capacity capacitor or rechargeable cell with capacity
C≧((Ipeak−Imax)×t)/(Vmax−Vmin)
Where
Ipeak—Peak load current
Imax—Maximum current drain from bus
t—Duration of the peak load current pulse
Vmax—Maximum operating voltage of the load
Vmin—Minimum operating voltage of the load
